(19) United States
(12) Patent Application Publication
(10) Pub. No.: US 2010/0132513 A1
(43) Pub. Date: Jun. 3, 2010

(54) CHAMPAGNE BOTTLE OPENER

(75) Inventor: Francisco Barbera Traspuesto, Pontevedra (ES)

Correspondence Address: ARENT FOX LLP, 1050 CONNECTICUT AVENUE, N.W., SUITE 400, WASHINGTON, DC, 20036, US

(73) Assignee: KOALA INTERNATIONAL HOSETELERIA, S.L., Pontevedra (ES)

(21) Appl. No.: 12/663,136

(22) PCT Filed: Jun. 4, 2008
(86) PCT No.: PCT/ES08/00405

§ 371 Date: Feb. 19, 2010

(30) Foreign Application Priority Data
Jun. 6, 2007 (ES) U200701214

(51) Int. Cl. B67B 7/04

(52) U.S. Cl. 81/3.47

(57) ABSTRACT

The present invention concerns a champagne bottle opener, easy to use in application thereof, comprising a means which prevents the cork capsule (8) from shooting off after opening thereof, as a consequence of the carbon dioxide contained in the bottle and which is characterized in that it comprises a principal body (1) wherein one end has pivotably mounted a fork-shaped head (4), between whose arms (5) fits the projecting portion of the champagne bottle closure stopper (8); said fork-shaped element has a pointed part or points (6) for insertion in the cork and with a horn-like extension (2), which check the loop or ringpull (7) corresponding with the end of the wire enmeshing the projecting part of the capsule (8) for closing the bottle.

### PURPOSE OF THE INVENTION

This invention refers to a Champagne bottle opener although it could be used for bottles containing other carbonated liquids that are closed with a cork, which has one of its ends protruding from the edge of the bottle rim.

The purpose of this invention is to achieve an opener that is easy to use, of fast operation and efficient in achieving its function, while also providing a means that prevents the cork from getting launched into the air after opening as a consequence of the force exerted by the carbonated liquid inside the bottle.

### INVENTION BACKGROUND

As commonly known, Champagne bottles are closed using a cork that has one end wider than the other, with the wider end projecting over the edge of the bottle neck; the cork is fastened to the bottle by means of a wire shaped as a cap, which covers the external portion of the cork and is girdled around the ring shaped rim limiting the bottle neck.

Opening of the Champagne bottle is carried out manually by pressing and pulling the cork upward or twisting with fingers around the cork in order to extract it gradually.

As a consequence of this opening procedure, there is a moment at which the cork is forced out by pressure built up by the carbonated liquid inside; this launching of the cork occurs in an uncontrolled fashion and may cause different types of accidents i.e., breaking of a lamp or other object, impacting a person's face, etc.

### INVENTION DESCRIPTION

The opener that is recommended has been designed to solve the problem described in the paragraph above in a simple but very efficient way, since this opener incorporates the means for retaining the bottle cork once it's opened.

Specifically, the opener of this invention is comprised of an elongated body that serves as a crow bar, which near its free end incorporates an appendage shaped as a horn, which is projected backwards on its lower side; this device can be hooked to the loop at the end of the wire mesh attached to the exterior part of the cork; the free end of this device also incorporates a head piece with two arms shaped like a fork; the bottle cork is placed between these arms with the particularity that this head on the transversal side of the fork has a sharp device; preferably two spikes that puncture the cork; all of this so that operation of the opener causes the cork to be extracted from the bottle neck and more importantly, it holds the cork so that it does not shoot out by hooking the opener's hook or appendage to the wire mesh of the cork.

In other words, it is a device that enables to open Champagne bottles quickly, easily, comfortably and safely.

This opener may be made of metal (iron, steel, aluminium, etc.), polyamide, or any other appropriate material.

### DESCRIPTION OF THE DRAWINGS

To complement the description that is subsequently going to be carried out and for the purpose of better understanding the characteristics of the invention; in accordance with a preferred example for carrying it out in a practical way, a set of drawings are provided along with the description, which represent the following in an illustrative but not a limiting fashion:

FIG. 1.—Shows a representation according to a general perspective of the opener of this invention.

FIG. 2.—Shows a different perspective; in this case of the opener's inner face that shows the horn shaped element or appendage and the head shaped like a fork in a semi-folded position with respect to the main body that is used as a crowbar.

FIG. 3.—Shows a lateral view of the assembly represented in the prior figure with the fork shaped head folded over the main body that is used as a crowbar.

FIG. 4.—Shows a lateral view of the opener's operation as used on a Champagne bottle cork, showing the cork wire end ring hooked to the appendage or hook included with the opener.

FIG. 5.—Shows a lateral view just like the figure prior, with the opener in its final position as used for opening the bottle; in other words, extracting the Champagne bottle cork.

### PREFERRED EMBODIMENT OF THE INVENTION

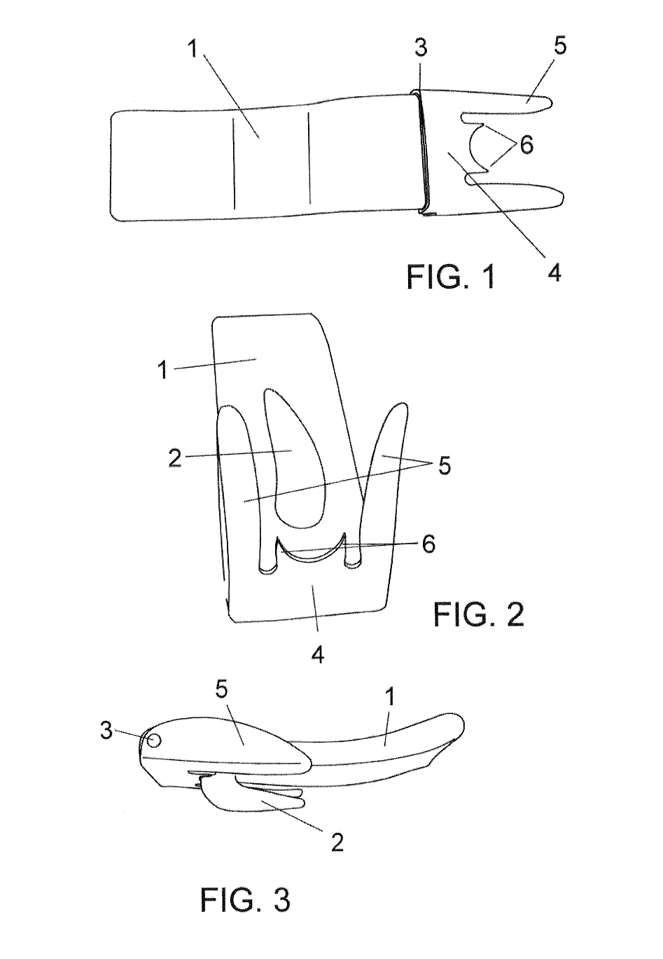

As shown in the figures, the opener of this invention is comprised of a main body (1), which is elongated, rectangular and slightly bent, with a general easy to grip shape so it can be perfectly held by the user. This body (1) includes a hook shaped appendage (2) on its inner side, while its free end is moveable by means of a transversal hinge (3), a head (4) shaped like a fork with two lateral arms (5) and a sharp element, which is specially comprised of two spikes (6) that emerge from the arms or lateral branches (5), which project from the transversal or rear fork branch that forms the head (4) as can be clearly seen in FIG. 1.

As previously stated, this opener can be made of polyamide, steel, aluminium or any other appropriate material and its application and functionality is as follows.

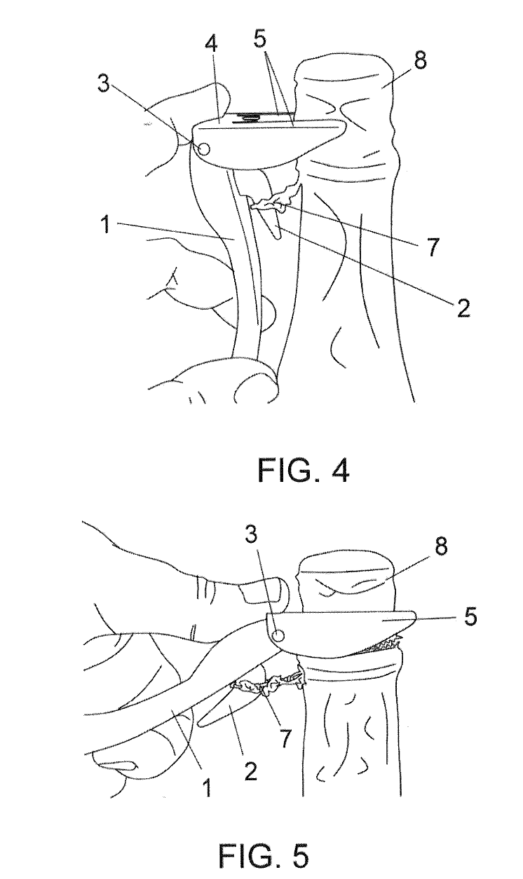

First of all, the loop or ring (7) formed at the end of the wire that normally meshes around the upper protruding section of a Champagne bottle cork (8) is hooked to the horn shaped appendage (2) as seen in FIGS. 4 and 5 so that subsequently and once the loop or ring at the end of the wire (7) is hooked, the lower part of the exposed part of the cork (8) is placed between the fork branches (5) that make up the head (4) that moves about the opener's main arm (1) until the spikes (6) or sharp element incorporated on that fork or head (4) puncture the cork (8) to subsequently carry out the twisting side to side of the cork (8) to extract the cork from the bottle neck; due to this extraction, the cork (8) will tend to be launched but this will not occur because the cork (8) will be retained by the wire that is hooked to the opener's appendage or horn (2), specifically from the openers (1) main arm.

In conclusion, this is an opener that enables to carry out the opening of bottles in a fast and easy way, while preventing the cork from being launched into the air.

1. Champagne bottle opener characterized because it is comprised of an elongated main body (1), which has a hinged, fork shaped head (4) mounted on one of its ends; the exterior part of the cork that closed the bottle (8) is placed between the arms (5) of this head; this fork has a sharp element or spikes (6) on its transversal or initial branch, which punctures the cork (8) that closes the bottle; additionally, the opener's main arm incorporates an appendage or horn (2) on its inner face that is projected backwards, to which the loop or ring (7) corresponding to the end of the wire that meshes around the external part of the cork (8) that closes the bottle is hooked, creating a means for retaining the cork after its extraction from the bottle.
